(19) United States
(12) Patent Application Publication
(10) Pub. No.: US 2026/0156718 A1
(43) Pub. Date: Jun. 4, 2026

(54) HEATING DEVICE

(71) Applicant: BorgWarner Inc., Auburn Hills, MI (US)

(72) Inventors: Volker Dezius, Affalterbach (DE); Alexander Dauth, Maulbronn (DE); Sisay Tadele, Friolzheim (DE)

(21) Appl. No.: 19/379,919

(22) Filed: Nov. 5, 2025

(30) Foreign Application Priority Data
Dec. 4, 2024 (DE) 102024136046.1

(51) Int. Cl. H05B 3/26

(52) U.S. Cl. CPC H05B 3/26; H05B 2203/016; H05B 2203/035

(57) ABSTRACT

A heating device with a heating plate including a metal plate, a conductor track and an insulator layer between the conductor track and the metal plate, a housing in which the heating plate is arranged, a circuit board with control electronics, and an electrical connector made of sheet metal. The electrical connector has a first end that is designed as a press-fit contact and is pressed into an opening in the circuit board, and a second end that makes electrical contact with the heating plate. A second end of the connector is welded to the heating plate.

### CROSS REFERENCE TO RELATED APPLICATIONS

This application claims priority to DE 10 2024 136 046.1 filed Dec. 4, 2024, the disclosure of which is hereby incorporated herein by reference.

### BACKGROUND

The present disclosure relates to a heating device with features known from DE 10 2022 132 476 B3.

The heating device known from DE 10 2022 132 476 B3 is a flow heater that comprises an electrical connector via which the heating plate is connected to a printed circuit board with control electronics. This connector is designed as a metal strip. A first end section of the sheet metal strip is soldered to the heating plate and a second end section of the sheet metal strip is inserted into the printed circuit board.

### SUMMARY

The present disclosure shows a way in which the printed circuit board can be connected to the heating plate in a cost-effective and reliable manner in a heating device of the type mentioned above.

This is achieved by a heating device with the features described herein. Advantageous refinements of the heating device are also described herein.

According to an embodiment of disclosure, the connecting element is welded to the heating plate. In this way, the circuit board can be connected to the heating plate in a cost-effective and reliable manner.

An advantageous further development provides that the first end of the connector is inserted into an opening in the printed circuit board. Preferably, this end is designed as a press-fit contact, but it can also be soldered to the printed circuit board in this opening.

A further advantageous refinement provides that the two ends of the connector are made of different metallic materials. The first end of the connector is intended to form an interference fit with a printed circuit board as a press-fit contact and therefore has to meet different material requirements than the second end, which is designed for a welded connection. Copper-based alloys, such as brass alloys, copper-tin or copper-nickel alloys, such as CuSn6 or CuNiSi3, have particularly good mechanical properties for press-fit contacts. Therefore, a first section of the electrical connector, which forms the first end, is preferably made of a copper-based alloy. Aluminum-based alloys, such as aluminum alloys with an aluminum content of at least 95% in weight, in particular at least 99% in weight, are particularly suitable for a second section of the connector, which forms the second end.

A further advantageous refinement provides for the connector to be welded to the heating plate via a nickel layer. The nickel layer is preferably applied as a top layer on the conductor track, or more precisely, on a contact section of the conductor track. However, it is also possible for the nickel layer to be applied directly to the insulating layer of the heating plate and to overlap with the conductor track. A nickel layer enables good weldability, particularly with an aluminum base alloy. The nickel layer preferably has a thickness of 5 μm to 50 μm, in particular 5 μm to 20 μm.

Another advantageous refinement provides that the conductor track of the heating plate and thus the heating resistor is made of an iron-chromium alloy. Iron-based conductor tracks enable cost-effective production and have an advantageous resistance characteristic over a wide temperature range. Alloys with an iron content of at least 60% by weight and a chromium content of 10% to 30% in weight are particularly suitable. The favorable properties of such alloys for heating conductor tracks can in many cases be improved by adding aluminum, for example 2% to 10% in weight. Direct welding with such conductor tracks is often difficult. It is therefore preferable to provide the heating plate with a nickel layer, for example as a top layer of a contact section of the conductor track, and to weld the connector to the nickel layer.

### BRIEF DESCRIPTION OF THE DRAWINGS

Further details and advantages are explained with reference to an embodiment and the accompanying figures.

FIG. 1 illustrates an embodiment of a heating device.

FIG. 2 shows schematically the electrical connection between a heating plate of this heating device and a printed circuit board.

Although the exemplification set out herein illustrates an embodiment of the invention, in one form, the embodiment disclosed below is not intended to be exhaustive or to be construed as limiting the scope of the invention to the precise form disclosed.

### DETAILED DESCRIPTION

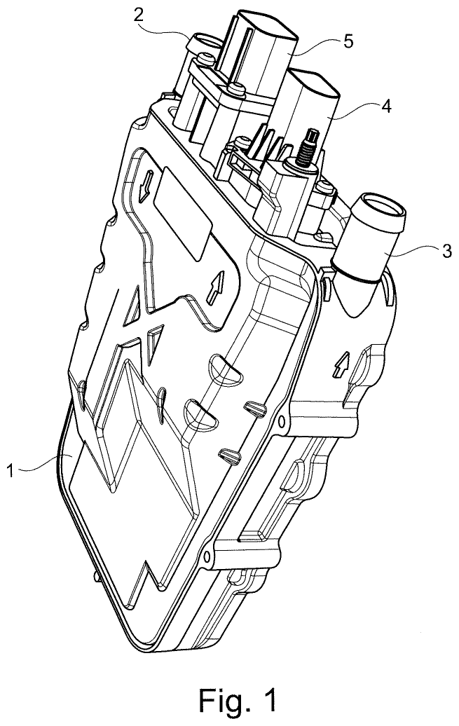

The heating device shown in FIG. 1 is a flow heater, e.g., an instantaneous water heater. The heating device has a housing 1 with a liquid inlet 2 and a liquid outlet 3, as well as electrical connections 4, 5. A flow channel for the liquid to be heated runs through the housing 1 from the liquid inlet 2 to the liquid outlet 3.

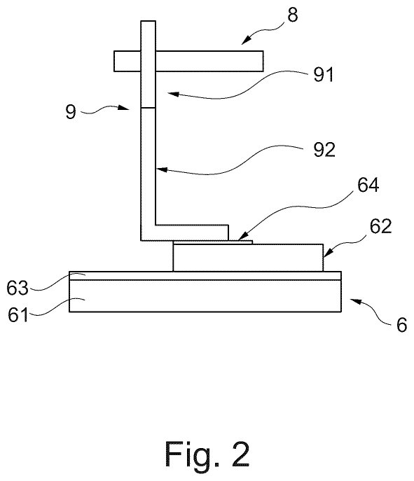

The flow channel runs along a heating plate 6, which is shown schematically in FIG. 2 together with a printed circuit board 8 carrying control electronics. The heating plate 6 comprises a metal plate 61 made, for example, of aluminum or steel, a conductor track 62 made, for example, of an iron-chromium alloy as a heating resistor, and an insulating layer 63 between the conductor track 62 and the metal plate 61. The conductor track 62 is covered with a nickel layer 64 in a contact section. The nickel layer 64 may, for example, have a thickness of 5 μm to 50 μm,in particular 5 μm to 20 μm.

The printed circuit board 8 carries control electronics for controlling the heating power. The conductor track 62 is electrically connected to the heating plate 6, more precisely to the conductor track 62, via a connector 9. The connector 9 is made of sheet metal, for example. A first section 91 of the connector 9 and thus a first end of the connector 9 are made of a copper-based alloy, for example a brass alloy, a copper-tin alloy or a copper-nickel alloy, and form a press-fit contact which is inserted into an opening in the printed circuit board 8 and forms an interference fit with the printed circuit board 8. A second section 92 of the connector 9, and thus a second end of the connector 9, is welded to the nickel layer 64 of the heating plate 6. The second section 92 of the connector 9 is made of an aluminum-based alloy, for example an alloy with an aluminum content of 95% in weight or more, in particular 99% in weight or more.

Press-fit contacts are designed to establish an electrical connection by means of an interference fit in a metallized hole in a printed circuit board or similar. Press-fit contacts must be deformed when pressed into a metallized hole. To facilitate this, press-fit contacts may have a bulging center section and be provided with a slot or opening in the bulging center section. The press-fit contact formed by the first section 91 of the connector 9 may be coated with nickel and/or tin to facilitate a good electrical connection with low resistance.

As shown in FIG. 2, the connector 9 is L-shaped and thus lies flat against the heating plate 6, in particular the nickel layer 64.

The two sections 91, 92 of the connector 9 may be joined together, for example, by welding or clinching. The joining technique of clinching is sometimes also referred to as press-joining or sealed clinch joint.

### LIST OF REFERENCE SYMBOLS

1 Housing
2 Liquid inlet
3 Liquid outlet
4 Electrical connection
5 Electrical connection
6 Heating plate
8 Printed circuit board
9 Connector
61 Metal plate
62 Conductor track
63 Insulating layer
64 Nickel layer
91 First section
92 second section

While this invention has been described as having an exemplary design, the present invention may be further modified within the spirit and scope of this disclosure. This application is therefore intended to cover any variations, uses, or adaptations of the invention using its general principles.

What is claimed is:

1. A heating device comprising:
a heating plate comprising a metal plate, a conductor track and an insulating layer between the conductor track and the metal plate,
a housing in which the heating plate is arranged,
a circuit board with control electronics, and
an electrical connector made of sheet metal, which makes electrical contact to the circuit board at a first end and to the heating plate at a second end, wherein the second end of the connector is welded to the heating plate.

2. The heating device according to claim 1, wherein the first end of the connector is designed as a press-fit contact and is pressed into an opening in the printed circuit board.

3. The heating device according to claim 1, wherein the two ends of the connector are made of different metallic materials.

4. The heating device according to claim 1, wherein a first portion of the electrical connector forming the first end is made of a copper-based alloy, while a second portion of the electrical connector forming the second end is made of an aluminum-based alloy.

5. The heating device according to claim 4, wherein the aluminum-based alloy has an aluminum content of at least 99% in weight.

6. The heating device according to claim 1, wherein the connector is welded to the heating plate via a nickel layer.

7. The heating device according to claim 6, wherein the nickel layer is arranged on the conductor track.

8. The heating device according to claim 6, wherein the nickel layer has a thickness of at least 5 μm.

9. The heating device according to claim 6, wherein the nickel layer has a thickness of no more than 50 μm.

10. The heating device according to claim 1, wherein the conductor track is made of an iron-chromium alloy.

11. The heating device according to claim 1, wherein the connecting element is an L-shaped sheet metal strip.
